(19) United States
(12) Patent Application Publication
(10) Pub. No.: US 2018/0195919 A1
(43) Pub. Date: Jul. 12, 2018

(54) DISPLACEMENT MEASUREMENT SYSTEM

(71) Applicant: FNSS SAVUNMA SISTEMLERI ANONIM SIRKETI, Gölbasi, Ankara (TR)

(72) Inventors: Berkay SALIHOGLU, Gölbasi, Ankara (TR); Ilker KURTOGLU, Gölbasi, Ankara (TR)

(21) Appl. No.: 15/740,669

(22) PCT Filed: Aug. 12, 2016
(86) PCT No.: PCT/TR2016/050287

§ 371 Date: Dec. 28, 2017

(30) Foreign Application Priority Data
Sep. 17, 2015 (TR) 2015/11663

(51) Int. Cl. G01L 5/14; G01B 5/30; G01M 7/08; G01M 17/007; G01N 3/313

(52) U.S. Cl. CPC G01L 5/14; G01B 5/30; G01N 3/313; G01M 17/0078; G01M 7/08

(57) ABSTRACT

A displacement measurement system enables accurate and easy measurement of the maximum displacement formed on plates which are used for military or civil purposes, especially in vehicle manufacture, and which are subjected to a blast or crash test.

### TECHNICAL FIELD

The present invention relates to the measurement of maximum displacement occurring due to load created by an blast or crash, on plates subjected to blast or crash test.

The present invention specifically relates to a displacement measurement system that enables accurate and easy measurement of the maximum displacement on plates subjected to blast or crash test.

### THE PRIOR ART

During blast or crash displacement measurements are made to explore the behavior, strength properties and deformation rates of plates used especially in vehicle manufacture for military or civil purposes.

Two types of deformation occurs on a plate that is affected by the load created by an blast or crash: plastic deformation and elastic deformation. Elastic deformation is the maximum deformation that the plate can attain and is temporary. Plastic deformation, on the other hand, is the last deformation that the plate experiences and is permanent. The sum of elastic and plastic displacements is called as total displacement. Various ways are being used to measure total displacement.

The most commonly used method for the measurement of the displacement created on the plate as a result of the blast or crash impact is measurement by a high-speed camera. This measurement method is especially useful in crash tests, but it is not very useful in highly explosive tests where ballistic plates are blasted. Considering camera safety, close-up shots cannot be made and hence, the measurement is not accurate.

Another method for the measurement of displacement is to use strain gages. Although strain gages are adequate for the measurement of low deformation displacements, they cannot be used for the measurement of displacements of high deformation due to their limited measurement capabilities.

Another method that can be utilized for the measurement of displacement occurring on the plate as a result of the impact of an blast or crash may be using laser distance sensors or potentiometers but these also are not convenient, especially in blast tests since the blast happens very rapid during the test and the speed of the blast is much below the time interval that the sensors can measure.

Consequently, the requirement to eliminate the disadvantages of the state of the art techniques being currently used for the measurement of displacement has made necessary an advancement in the related technical field.

### PURPOSE OF THE INVENTION

The invention relates to an embodiment of displacement measurement system developed to eliminate the abovementioned disadvantages and to meet the abovementioned requirements and designed to accurately and easily measure the maximum displacement due to the load created by a blast or crash on plates subjected to a blast or crash test.

The purpose of the invention is to ensure that the deformation formed on the plate subjected to the blast or crash test also formed on the displacement measurement system that is the subject of the invention.

Another purpose of the invention is to ensure a measurement based on mechanical deformation through establishing the deformation formed on the plate subjected to the blast or crash test also on the displacement measurement system that is the subject of the invention.

Still another objective of the invention is to ensure that the necessity for elements which bear the risk of making restricted and inaccurate measurements, such as strain gages, high-speed cameras, laser distance sensors, etc., is eliminated in virtue of the practice of a measurement based on mechanical deformation.

A further objective of the invention is to ensure that more accurate test results are obtained by eliminating the necessity of measuring elements which bear the risk of making restricted and inaccurate measurements and using a measurement based on mechanical deformation.

A still further objective of the invention is to ensure that blast or crash tests are carried out without safety concerns and at low costs, by eliminating the necessity for expensive and electronic equipment such as high-speed cameras and laser distance sensors.

The structural and characteristic properties of the present invention will be more clearly acknowledged by the below figures and the detailed disclosure written referencing to them and thus, the assessment should be made taking into consideration these figures and the detailed disclosure.

### BRIEF DESCRIPTION OF THE FIGURES

FIG. 1: perspective view of the displacement measurement system from below

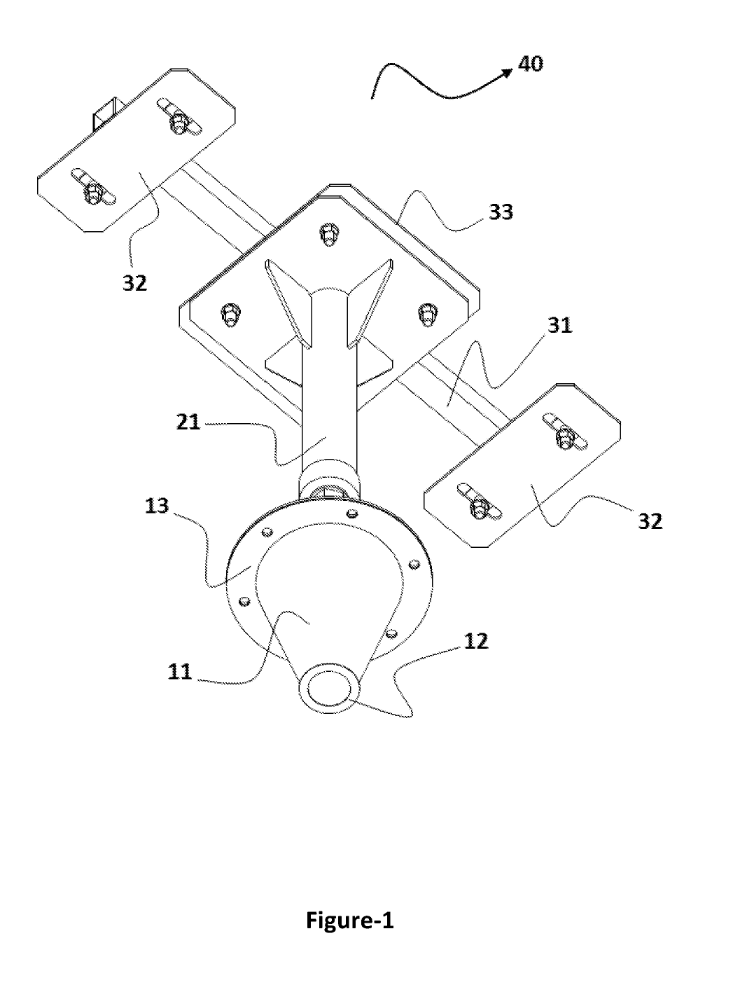

FIG. 2: perspective view of the displacement measurement system from above

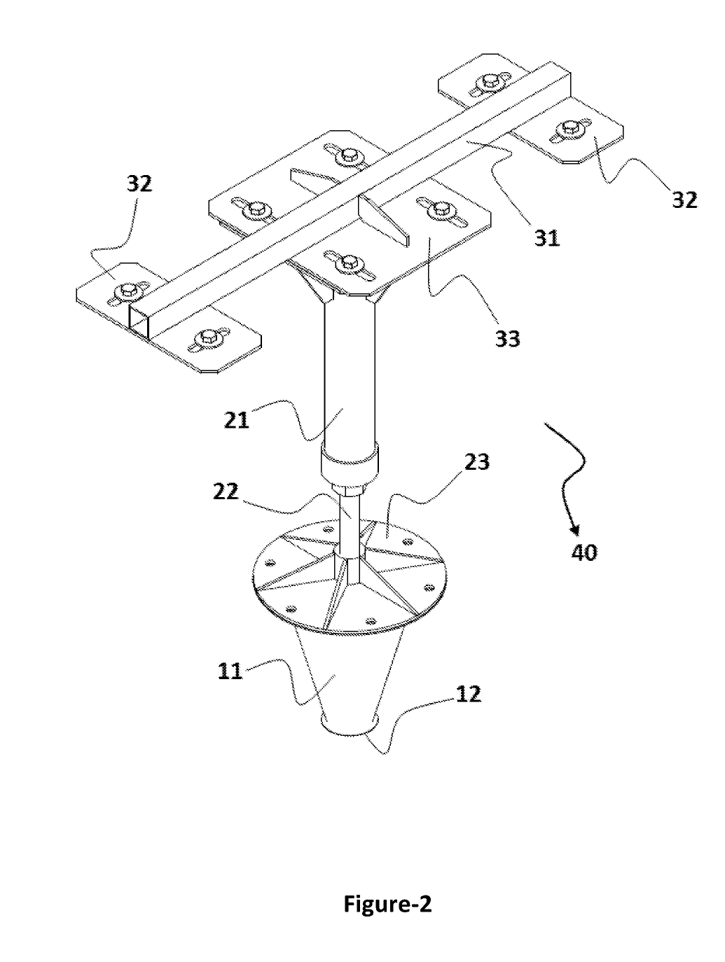

FIG. 3: perspective view of the conical measurement end

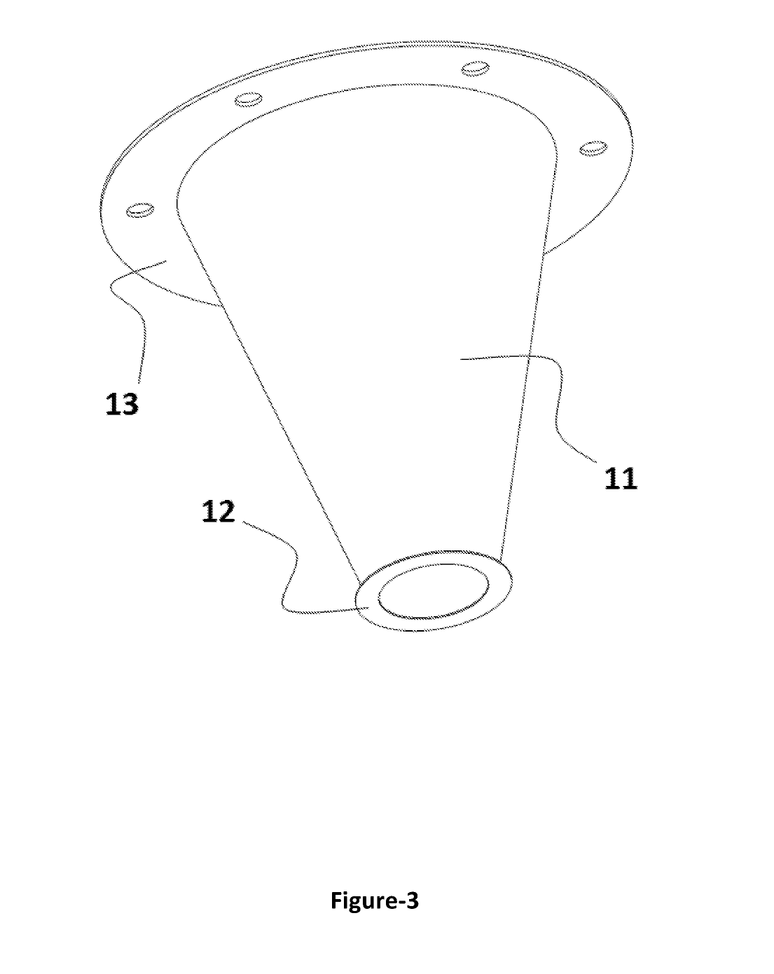

### REFERENCE NUMBERS

11. conical measurement end
12. contact opening
13. connection surface
21. main body
22. worm gear
23. tray
31. beam
32. supporting plate
33. connection plate
40. displacement measurement system

### DETAILED DESCRIPTION OF THE INVENTION

The present invention relates to a displacement measurement system (40) that enables accurate and easy measurement of the maximum displacement formed on plates used for military or civil purposes, especially in vehicle manufacture, and subjected blast or crash tests.

The displacement measurement system (40) that is the subject of the present invention comprises a conical measurement end (11), a main body (21) and a worm gear (22) in general. The conical measurement end (11) comprises a contact opening (12) to contact the plate to be subjected to the blast or crash test and a connection surface (13) to provide the connection with the worm gear (22). The connection between the connection surface (13) at the conical measurement end (11) and the worm gear (22) is provided by a platform (23).

To fix the displacement measurement system (40) on the plate to be tested; a connection plate (33) where the main body (21) is positioned, supporting plates (32) to provide support to the connection plate (33) and a beam (31) to connect the connection plate (33) and the supporting plates (32) to each other are used.

The position of the conical measurement end (11) with respect to the plate to be subjected to the blast or crash test is regulated by the worm gear (22). Adjusting the height by the worm gear (22) ensures that the contact opening (12) at the conical measurement end (11) completely contacts the plate to be subjected to the blast or crash test. The displacement measurement system (40), fixed through the connection plate (33), supporting plates (32), the beam (31) and the worm gear (22), is become ready for the blast or crash test.

The plate, which is deformed by the load created by the blast or the crash during the test, also causes the conical measurement end (11) that contacts it to deform. The deformation created on the conical measurement end (11) is of the same quantity with the instantaneous total deformation experienced by the plate being tested. The measurement taken on the conical measurement end (11) gives the total deformation amount of the plate tested. In addition, the amount of the plastic (permanent) deformation on the tested plate is obtained again by measuring on the plate. Thus, the elastic, plastic and total deformation amount created on the plate is measured over test stage.

Since the measurement made by the displacement measurement system (40) that is the subject of the present invention is completely based on mechanical deformation, since the created deformation has physically measurable quantity and since equipment such as high-speed cameras, strain gages and laser distance sensors are not necessary; displacement measurement with low-cost, minimized error rate, free of restricting effects and equipment safety considerations is carried out.

1. A displacement measurement system used to measure the displacement due to deformation caused by the load created as a result of a blast or crash on plates subjected to a blast or crash test, characterized by comprising a conical measurement end

2. The conical measurement end according to claim 1, characterized by comprising a contact opening and a connection surface.

3. The displacement measurement system according to claim 1, characterized by comprising a worm gear, a main body, a platform, a beam, a connection plate and supporting plates.
